(19) United States
(12) Patent Application Publication
(10) Pub. No.: US 2011/0204136 A1
(43) Pub. Date: Aug. 25, 2011

(54) ELECTRONIC DEVICE ACTIVATED BY CONDUCTIVE INK PATTERNS

(75) Inventor: Timothy Harry Bush, Oakbrook Terrace, IL (US)

(73) Assignee: CREATA (USA) INC., Oakbrook Terrace, IL (US)

(21) Appl. No.: 13/029,026

(22) Filed: Feb. 16, 2011

Related U.S. Application Data
(60) Provisional application No. 61/338,122, filed on Feb. 16, 2010.

(51) Int. Cl. G06F 17/00; G06K 7/06; G06K 19/06

(52) U.S. Cl. 235/375; 235/441; 235/492

(57) ABSTRACT

The invention provides an electrical device activated by conductive ink patterns applied to an activation strip which includes a plurality of electrical contacts disposed in an array adjacent to each other. Also included is reader circuitry connected to said plurality of electrical contacts and a housing arranged to contain said reader circuitry and to locate the plurality of electrical contacts. The invention is arranged so that the housing locates the plurality of contacts to facilitate movement of an activation strip relative to the contacts with the contacts touching the activation strip and the contacts arrayed across the width of the activation strip. The provision of an activation strip is also within the scope of the invention.

### BACKGROUND OF THE INVENTION

The present invention relates generally to an electronic device activated by conductive ink patterns and in preferred embodiments can provide an electronic entertainment device activated by conductive ink patterns that plays music.

### DISCLOSURE OF THE INVENTION

According to one aspect of the present invention there is provided an electrical device activated by conductive ink patterns applied to an activation strip which includes:

a plurality of electrical contacts disposed in an array adjacent to each other; and
reader circuitry connected to said plurality of electrical contacts; and
a housing arranged to contain said reader circuitry and to locate the plurality of electrical contacts;
wherein the housing locates the plurality of contacts to facilitate movement of an activation strip relative to the contacts with the contacts touching the activation strip and the contacts arrayed across the width of the activation strip.

In a preferred embodiment a contact acts in combination with a conductive ink marking to provide a switch with the state of said switch being read by the reader circuitry.

Preferably two adjacent contacts form elements of a switch, said switch being closed when a conductive ink marking is present between the contacts and touches both contacts.

Preferably the reader circuitry detects changes in electrical resistance of the surface of the activation strip touching at least one contact as the strip moves relative to the contact.

In some embodiments the reader circuitry is arranged to differentiate three of more levels of electrical resistance of the surface of a strip touching a contact.

In such embodiments the reader circuitry can be arranged to read a data word from each conductive ink marking with the amount of data present in each word being dependent on the number of resistance levels the reader circuit is arranged to detect.

However in a preferred embodiment the reader circuitry is arranged to differentiate only two levels of electrical resistance of the surface of a strip touching a contact.

Preferably the reader circuitry interprets a conductive ink pattern disposed across the width of a strip as a data word containing a number of bits related to the number of contacts.

Preferably the reader circuitry plays encoded content marked on an activation strip in the order in which contacts touch each data word marked across the width of the strip with the distance between each consecutive data word marked along the length of the strip providing playback timing information.

Preferably the reader circuitry includes a speaker configured to play audio signals encoded into the conductive ink patterns marked on a activation strip.

In some embodiments the reader circuitry includes or is associated with at least one display screen.

Preferably the electrical device provides an electronic entertainment device that is activated by conductive ink patterns.

Preferably the direction of movement and speed of movement of an activation strip relative to the contacts modifies the playback of content encoded into the conductive ink patterns by the reader circuitry.

Preferably the reading of encoded content from an activation strip by the reader circuitry triggers playback of a series of individual notes or a song.

However in other embodiments the reading of encoded content from an activation strip by the reader circuitry triggers one or more other entertainment playback actions including playback of vocal narratives, sound effects, musical compositions, visual images, audio, video or video animation.

Preferably the reader circuitry includes or is associated with at least one memory element configured to store entertainment content, with content read from an activation strip providing an access retrieval address for said stored entertainment content.

In some embodiments the contacts are moved relative to the strip and the strip remains stationary when encoded content is read from an activation strip.

In such embodiments the housing can include at least one roller element to assist the motion of the contacts over the strip.

In such embodiments the housing can include at least one substantially linear guide edge provided on a side of the housing to guide the motion of the contacts over a strip when the guide edge is engaged with a guide rail.

In such embodiments the housing can include at least one alignment marking on a front face of the housing to assist in aligning the contacts with the conductive ink patterns marked on a strip as the contacts move over the strip.

In such embodiments an underside surface of the housing can include at least one channel arranged to receive a strip and to guide the motion of the contacts over the strip.

However in a preferred embodiment the strip is moved relative to the contacts and the contacts remain stationary when encoded content is read from the strip.

Preferably the housing includes a channel to guide the motion of the strip over the contacts.

Preferably the entire front or rear end of a strip is inserted into the channel to control the motion of the strip over the contacts.

Preferably the channel includes a contact guide.

Preferably the housing includes a feed mechanism to promote motion of the strip over the contacts.

In some alternative embodiments a portion only of the front or rear end of a strip is inserted into the channel to control the motion of the strip over the contacts.

In some embodiments the electronic device is formed integrally with an additional article. For example in some embodiments the electronic device can be formed integrally with a book.

Preferably different conductive patterns marked on different activation strips result in different playback actions by the reader circuitry.

According to a further aspect of the present invention there is provided an activation strip formed from a media capable of retaining applied conductive ink patterns, said media being marked with conductive ink patterns capable of being read by an electronic device, wherein the media is formed into a strip capable of relative movement with respect to an array of contacts formed within said electronic device to read content encoded within the conductive ink patterns marked on the media.

Preferably the media provides at least one surface for the application of conductive ink patterns.

In some embodiments the conductive ink pattern are applied to both sides of the activation strip.

Preferably conductive ink patterns are marked on various flexible and rigid media including printed paper, board stock, film, plastic sheets, or stickers.

Preferably an activation strip is formed in the shape of a strip, card or sheet.

Preferably conductive ink patterns are formulated to close at least one circuit or switch when they touch electrical contacts of an electronic device.

Preferably conductive ink markings composing a pattern are aligned across the width of the strip.

Preferably a conductive ink pattern includes markings oriented in two directions.

Preferably the length of conductive ink pattern marked of the activation strip controls the amount of content capable of being read from the activation strip by an electronic device.

In some embodiments conductive ink patterns are printed by using conventional printing means. For example such printing methods may use a stamp, marker, pen, pencil, or similar writing or decorating device accessible to a wide range of people. Furthermore such conventional printing means may include computer based printers such as inkjet printers accessible to people in a home or office environment.

Those skilled in the art will appreciate that activation strips may be printed by the ultimate end user of the strip, or alternatively may be printed in bulk by a third party for eventual distribution to end users.

However, preferably a conductive ink pattern is applied to the activation strip using printing machinery. In such cases well known relatively high volume printing technology or machinery may be used by third parties who distribute activation strips to end users.

Preferably the activation strip is decorated with non-conductive ink.

Preferably the leading edge of the activation strip is shaped for insertion into a channel formed in an electronic device.

Preferably visual alignment guidelines are printed on a surface of the activation strip to align the contacts of an electronic device with a conductive ink pattern.

In a preferred embodiment the invention can provide a music toy which includes: a housing, contact guide, electronic components that reside within the housing, and a strip of material with a conductive ink pattern, that slides between the housing and contact guide thereby activating the electronic components.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide an electronic entertainment device that is activated by conductive ink patterns.

Another object is to provide an Electronic Device Activated By Conductive Ink Patterns that receives a strip of material with one or more conductive ink patterns that, when transported through or past the device, allows conductive ink dots to align with and touch electrical contacts thereby causing specific circuits to close resulting in the activation of specific functions.

Another object is to provide an Electronic Device Activated By Conductive Ink Patterns that results in the activation of one or more entertainment experiences including, but not limited to: the triggering of audio, video, animation, or multimedia experiences.

Another object is to provide an Electronic Device Activated By Conductive Ink Patterns that activate a specific function, such as playing a series of individual notes or a song when a strip of material with a conductive dot pattern is transported through the electronic device.

Another object is to provide an Electronic Device Activated By Conductive Ink Patterns that utilises one or more strips of material, each with its own conductive ink pattern and related function.

Another object is to provide an Electronic Device Activated By Conductive Ink Patterns that have dots that are positioned in one direction in order to align with a specific electrical contact and in a second direction to initiate activation of each circuit the proper time when the material strip is transported through the device at a reasonably constant speed.

Another object is to provide an Electronic Device Activated By Conductive Ink Patterns that can be printed on various flexible and rigid materials such as printed paper, board stock, film, plastic, stickers, or other material.

Another object is to provide an Electronic Device Activated By Conductive Ink Patterns that allows the user to vary the activation experience by controlling the speed and direction that the strip travels.

Another object is to provide an Electronic Device Activated By Conductive Ink Patterns that allows the user to create their own experience by designing their own conductive ink dot pattern on a material strip featuring fixed guide marks that align the user defined dots with the electric contacts.

Another object is to provide an Electronic Device Activated By Conductive Ink Patterns that can be applied a material strip via commercial printing methods or by the user via a marker, pen, stamp or similar device containing conductive ink, paint or pencil lead.

Another object is to provide an Electronic Device Activated By Conductive Ink Patterns that can be printed onto the material strips along with non-conductive decorative and instructional graphics.

Another object is to provide an Electronic Device Activated By Conductive Ink Patterns that can be printed on material that is manufactured in a variety of shapes and sizes including but not limited to: strips, cards, or sheets.

Another object is to provide an Electronic Device Activated By Conductive Ink Patterns that with the proper electronic components, allows a conductive dot or pattern of conductive dots to activate more sophisticated functions such as triggering vocal narratives, sound effects, musical compositions, and/or visual images, video, and animation.

Other objects and advantages of the present invention will become obvious to the reader and it is intended that these objects and advantages are sill in the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of this application. The following should be considered as examples only of how the invention may be implemented in a number of embodiments and should in no way be seen as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1: FIG. 1 is an upper perspective view of the present invention. This view primarily shows the channel 13, the contacts 31, and the channel opening 15. The contact guide 40 has been removed for viewing.

FIG. 2: FIG. 2 is an upper perspective view of the present invention. This view primarily shows the activation strip 20 and the assembled housing 10.

FIG. 3: FIG. 3 is a PCBA diagram of the present invention. FIG. 3 is a circuit diagram showing the printed circuit board assembly (PCBA).

FIG. 4: FIG. 4 is a bottom view of the present invention. FIG. 4 shows the inside of the contact guide 40.

FIG. 5: FIG. 5 is an upper perspective view of the present invention, this view shows how the activation strip 20 passes through the channel 13, channel openings 15, and the housing 10.

FIG. 6: FIG. 6 is an upper perspective view of the present invention. This view primarily shows how the user can apply conductive ink dots to the activation strip 20.

FIG. 7: FIG. 7 is an alternative embodiment of the present invention. FIG. 7 is an upper perspective view. This view shows an alternative variation wherein the housing 10 may be transported over, and thereby activated by a conductive dot pattern 21.

FIG. 7a: FIG. 7a is an alternative embodiment of the present invention. FIG. 7a is a lower perspective view. This view shows an alternative variation wherein the housing 10 may have a channel 13 and contacts 31 on the bottom.

FIG. 7b: FIG. 7b is an alternative embodiment of the present invention. FIG. 7b is a lower perspective view. This view shows an alternative variation wherein the housing 10 may have contacts 31 on the bottom.

FIG. 7c: FIG. 7c is an alternative embodiment of the present invention. FIG. 7c is a lower perspective view. This view shows an alternative variation wherein the housing 10 may have contacts 31 on the bottom and wheels or similar method of transporting a housing across a surface.

FIG. 7d: FIG. 7d is an alternative embodiment of the present invention. FIG. 7d is an upper perspective view. This view shows an alternative variation wherein the housing 10 may be moved across a surface bearing a conductive ink pattern 21 and guided by printed markings.

FIG. 7e: FIG. 7e is an alternative embodiment of the present invention. FIG. 7e is an upper perspective view. This view shows an alternative variation wherein the housing 10 may be moved across a surface bearing a conductive ink pattern 21 and guided by an edge that is parallel to the conductive ink pattern 21.

FIG. 8: FIG. 8 is an alternative embodiment of the present invention. FIG. 8 is an upper perspective view. This view shows all alternative variation wherein the housing 10 may resemble a card reader. The user can slide the activation strip through the reader in a different way.

FIG. 8a: FIG. 8a is an alternative embodiment of the present invention. FIG. 8a is a side view of FIG. 8. This view shows show the channel where the activation strip will travel and an example of where the contacts 31 could be positioned.

FIG. 8b: FIG. 8b is an alternative embodiment of the present invention. FIG. 8b is a top view. This view shows an alternative variation herein the housing 10 is affixed to another object like a book. The activation strip 20 is fed through the housing 10 by the user.

FIG. 8c: FIG. 8c is an alternative embodiment of the present invention. FIG. 8c is a bottom side view of FIG. 8b. This view shows an alternative variation wherein the housing 10 is affixed to another object like a book. This view shows the channel where the activation strip will travel and an example of where the contacts 31 could be positioned.

### DETAILED DESCRIPTION OF EMBODIMENTS OF THE INVENTION

### A. Overview

Turning no descriptively to the drawings, in which similar reference characters denote similar elements throughout the several views, the figures illustrate a housing, contact guide, electronic components that reside within the housing, and a strip of material with a conductive ink pattern, that slides between the housing and contact guide thereby activating the electronic components.

### B. Housing

The housing contains the electronic components and provides a channel through which the activation strip with conductive ink pattern can be fed, thereby activating the electronic components.

The housing is comprised of an upper portion and a lower portion. The upper surface of the upper portion features an activation strip receiving channel. The receiving channel has an opening that exposes the electrical contacts. The channel has two channel slots at opposite ends of the channel. Screws are used to affix the contact guide, upper portion, and lower portion together. Sound holes are located on the upper surface of the upper portion.

The housing may come in a variety of shapes and sizes. The receiving channel can be designed to accommodate activation strips that come in a variety of shapes and sizes. Screws may not be required for the present invention and their use is illustrated as only one embodiment for assembling the present invention. Depending on the design, the sound holes may be placed in a different location. An on/off switch may be positioned on the upper or lower portion, or both.

### C. Activation Strip

The material strip with conductive ink dot pattern is fed through the housing and the dots activate the electronic components.

The activation strip is comprised of a flexible, printable material and provides at least one surface for the application of conductive ink patterns. The conductive ink dots that comprise the printed ink pattern are positioned in two directions. The leading edge of the activation strip is shaped in a way that makes it easy to insert the strip into the channel slot.

The conductive ink dots are formulated so that when they come in contact with the electrical contacts, a circuit is closed and a function is activated.

When activated, this device plays a melody. This activation method is suitable for the activation of many different kinds of electronic functions. The melody function is illustrated as only one embodiment of the present invention.

The distance between the conductive ink dots positioned on the x-axis determines which electrical contacts are touched and therefore, which circuits are closed and which tones are activated.

The distance between the dots that are positioned on the y-axis together with the speed the activation strip travels, determines the relative timing of the activation.

The conductive ink pattern can be applied to both sides of the activation strip.

The conductive ink pattern is applied to the activation strip using conventional printing methods such as offset printing, silkscreen or inkjet.

The distance between the dots positioned on the y-axis is determined by the natural rhythm of the melody and the speed at which the activation strip is transported past the contacts.

The activation strip can be made from a variety of flexible and rigid materials.

The activation strip can travel forward and backward through the channel. When the strip travels in the primary direction, the sequence of notes will play the intended melody. When the direction of travel is reversed, the sequence of notes will play in reverse.

The conductive ink dots can be configured in an infinite number of patterns, each pattern representing a unique activation sequence and entertainment experience.

The conductive ink pattern needs to be facing the contacts and touch the contacts in order to achieve the intended activation.

The length of pattern is dependent upon the length of the melody and the position of the conductive ink dots. The length of the activation strip is dependent on the length of the pattern.

Conductive dots can be aligned so that they close one or more circuits at a time thereby activating one or more functions at a time.

The ink used to make the conductive dots can have one or more levels of resistance. The changes in resistance can be recognized by one or more integrated circuits and different levels of functionality can be realized.

The ink dots do not need to be square. They can be a variety of shapes and sizes.

### D. Printed Circuit Board Assembly

The PCBA is comprised of electronic components that together, play notes, music, and other sounds, and are activated by the conductive ink dots on the material strip as it travels through the housing.

The PCBA consists of a group of electronic components including integrated circuit, contacts, power source, speaker, wires, and an on/off switch.

The electronic components can be affixed directly to the circuit board or they can be separated from the board and connected to the board via electrical connections.

There are currently nine contacts. Each contact is aligned with one of nine rows of conductive ink dots that make up the conductive dot pattern on the activation strip.

When a conductive ink dot comes in contact with its corresponding contact, a circuit is closed and the PCBA is activated. In this specific design, each row represents a different musical note and when the circuit is closed, a specific tone is heard. The number of contacts and corresponding rows of conductive ink dots can change to accommodate more or less functionality. One or more circuits can be activated at a time. In this specific design, single notes and chords can be played.

The conductive dots and corresponding contacts provide a method for activation.

The functionality of the PCBA is not limited to generating simple musical tones and is illustrated as only one embodiment for the present invention. As an example, the current melody PCBA can consist of video game components, LCD screens, printed electronics, lights, and a variety of music and voice functions.

The PCBA and related contacts may be configured in such a way that the contacts and channel opening may be positioned on an outer surface of the housing and then the housing would be moved over, and in contact with, a surface printed with a conductive ink pattern.

The speaker is able to play tones or voice quality sounds.

The power source consists of batteries. A variety of different batteries can be used.

The wires connect the integrated circuit to related components.

The on/off switch is a simple switch but it can be a switch that is activated by other means including but not limited to: light, sound, vibration, magnet, capacitance, resistance, etc.

### E. Contact Guide

The contact guide properly positions the material strip so that the conductive ink pattern makes proper physical contact with the contacts that trigger the electronic function.

The contact guide has an exterior and interior surface. The exterior surface is a protective and or decorative surface. Positioned within the interior surface is a roller that is fixed mounted on a shaft. Also positioned on the interior surface are ribs extending downward toward the upward facing surface of the channel. The contact guide is fixedly positioned above the receiving channel thereby covering the channel. When the contact guide is in position, a gap is formed in the channel area between the upper housing and the contact guide and channel slots appear on both ends of the channel.

The roller and shaft aid in transporting the activation strip through the channel. The pressure ribs place pressure on the activation strip ensuring that the conductive ink dots touch the appropriate contract. The channel slots provide entry and exit for the activation strip. The contact guide together with the channel, form a space for the activation strip to travel between the channel slots.

### F. Connections of Main Elements and Sub-Elements of Invention

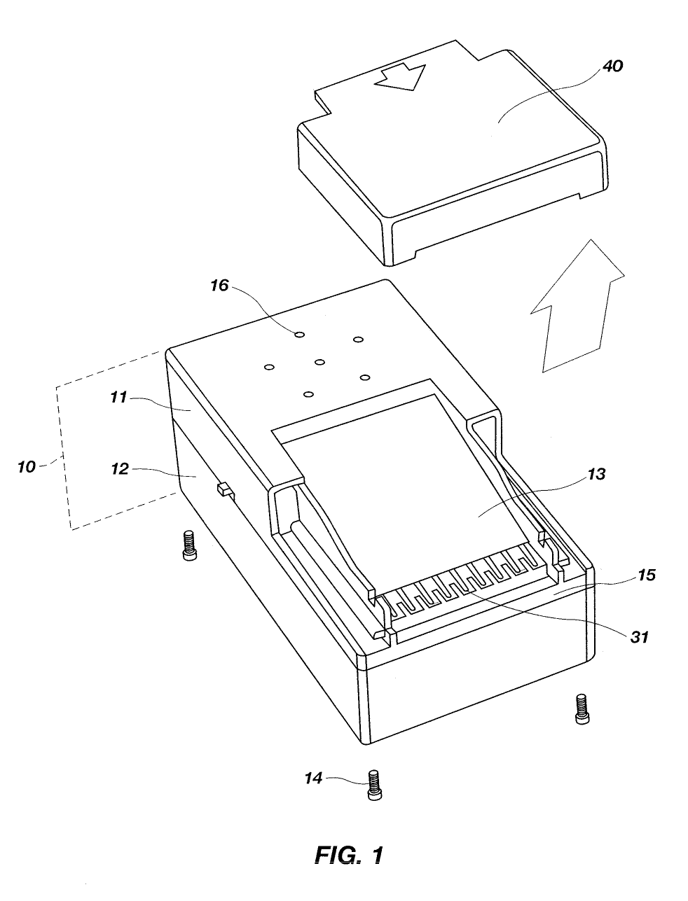

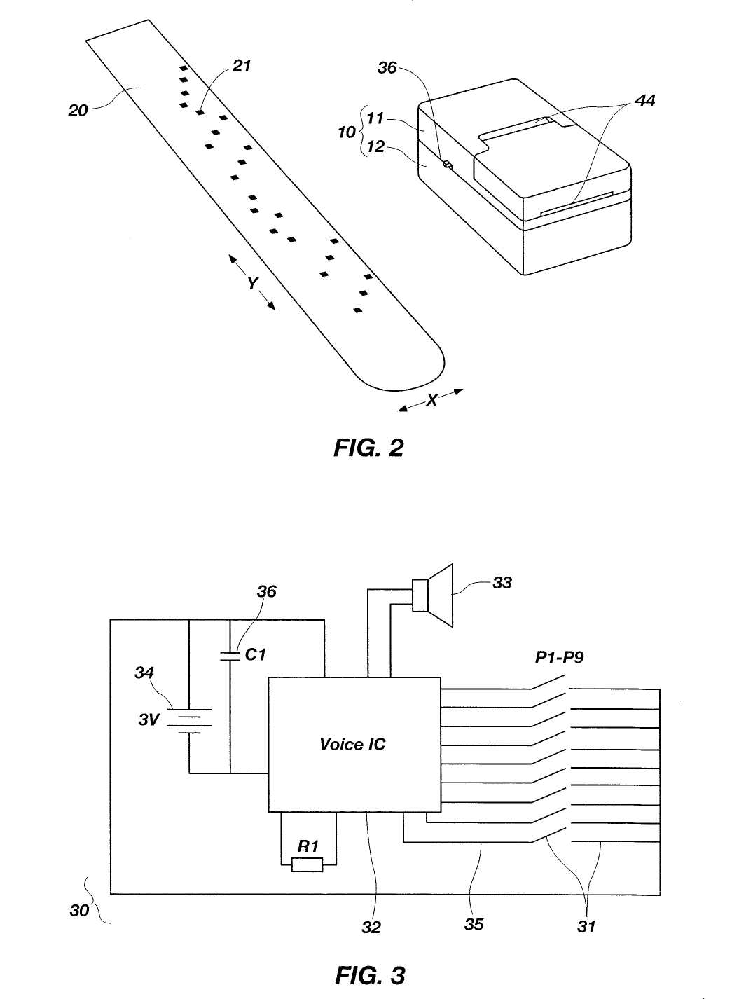

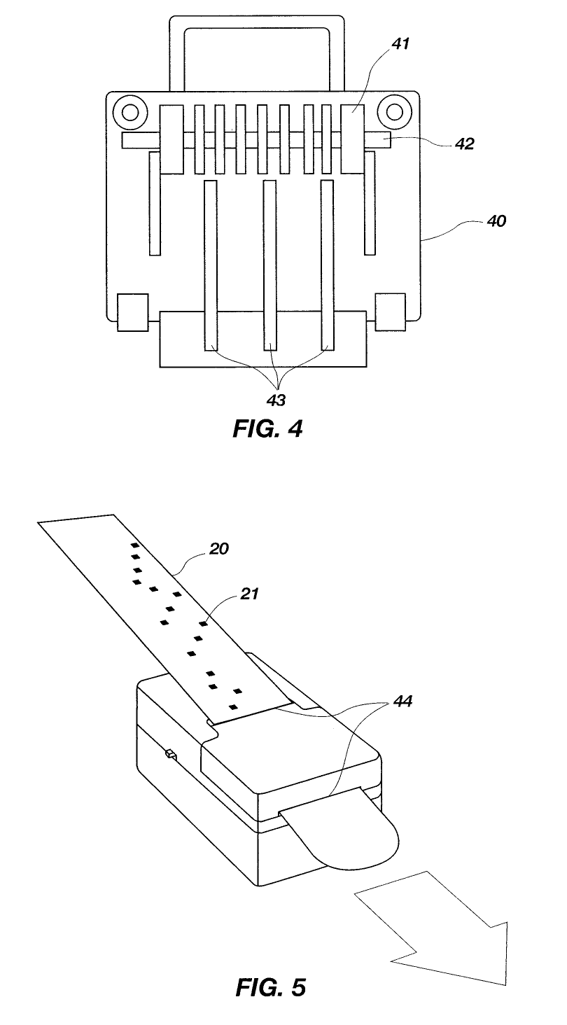

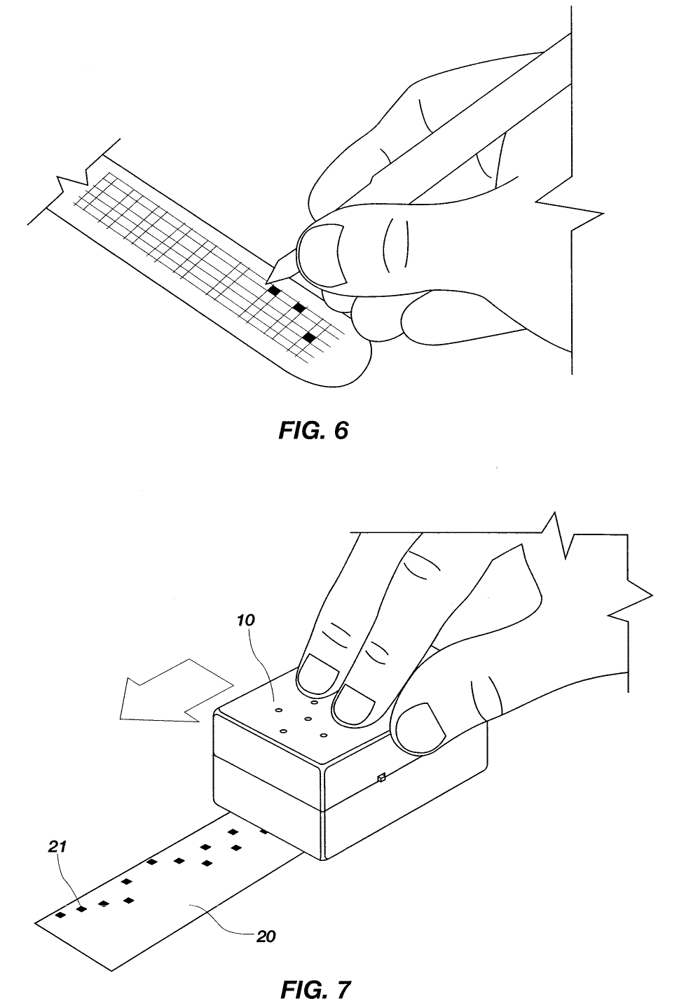

The upper portion 11 of the housing 10 is connected to the lower portion of the housing 12 using screws 14 as shown in FIG. 1 of the drawings. Screws 14 can be replaced by or augmented by attachment methods commonly utilized in the manufacturing of plastic or metal products. The contact guide 40 is attached to the upper portion 10 of the housing 10 by screws as shown in FIG. 1 of the drawings. The roller 41 and shaft 42 are positioned inside the contact guide 40 in such a way as to facilitate the transport of the activation strip 20 through the channel 13 as shown in FIGS. 1 and 4 of the drawings. The pressure ribs 43 are located within the contact guide 40 and they facilitate the proper contact between the conductive ink pattern 21 on the activation strip 20 and the contacts 31 residing within the channel opening 15 as shown in FIGS. 1, 3 and 4. The channel slots 44 are formed when the contact guide 40 is affixed to the upper portion 11 of the housing 10 as shown in FIG. 2 of the drawings. The PCBA 30 resides within the housing 10. The speaker 33 resides within the housing 10, is positioned beneath the sound holes 16 and is electrically connected to the PCBA 30 via wires 35 as shown in FIGS. 1 and 3. The contacts 31 reside within the housing 10 and are positioned within the channel opening 15 and are electrically connected to the PCBA via wires 35 as shown in FIGS. 1 and 3 of the drawings. The power source 34 resides within the housing 10 and is electrically connected to the PCBA 30 via wires 35 as shown in FIG. 3 of the drawings.

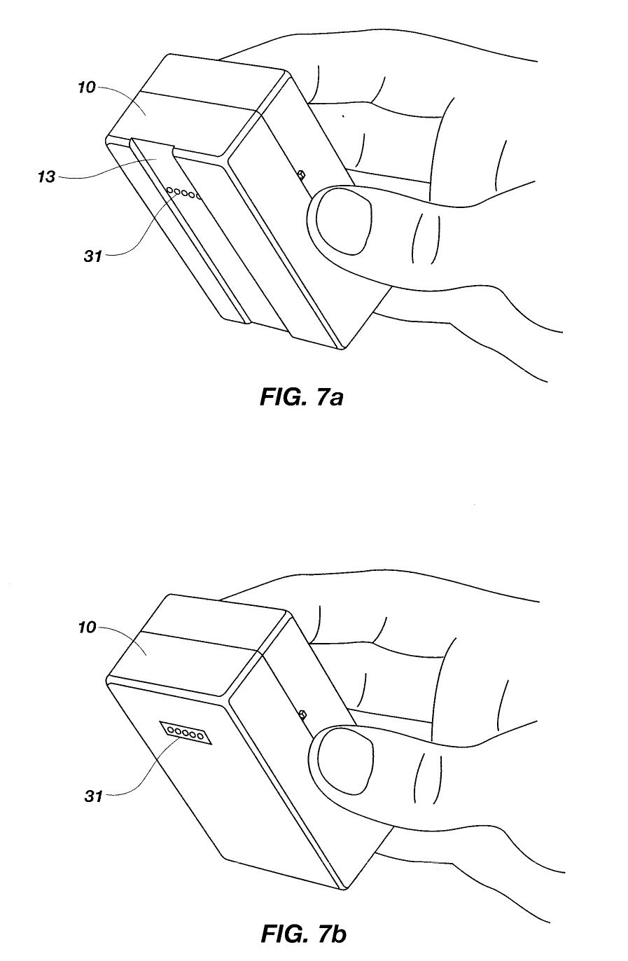

The on/off switch 36 resides both inside and outside the housing 10 and is electrically connected to the PCBA 30 via wires 35 as shown in FIGS. 2 and 3. The integrated circuit 32 is electrically connected to the PCBA 30 as shown in FIG. 3 of the drawings. The PCBA 30 as shown in FIG. 3 of the drawings resides within the housing 10 as comprised of the upper portion 11 and lower portion 12. As shown in FIGS. 1 and 2 of the drawings and is electrically connected to all the electronic sub elements required for activation and functionality. The conductive ink pattern is affixed to the activation strip 20 as shown in FIG. 2. The conductive ink pattern on the activation strip 20 makes physical contact with the contacts 31 when it is transported through the channel slots 44 and along the channel 13 thereby activating the PCBA 30 as shown in FIGS. 2, 3 and 5.

### G. Alternative Embodiments of Invention

Alternatively, the conductive ink pattern 21 can be made using visible or clear conductive ink and the conductive ink pattern 21 can be applied to one or more surfaces of the activation strip 20. Various types of conductive ink can be used to create the conductive ink pattern 21.

Alternative Variation: Alternatively, the conductive ink pattern 21 can have different levels of conductivity wherein the PCBA 30 senses this difference and provides different levels of functionality for different levels of conductivity. Differences in conductivity can exist at different points within a conductive ink pattern 21 or can exist between different patterns.

Alternative Variation: Alternatively, the activation strip 20 can come in a wide variety of shapes, sizes, including but not limited to strips, sheets, graphic shapes and collectable cards. Activation strips 20 can be distributed singly or in groups.

Alternative Variation: Alternatively, conductive ink patterns 20 can come in a wider variety of shapes and configurations.

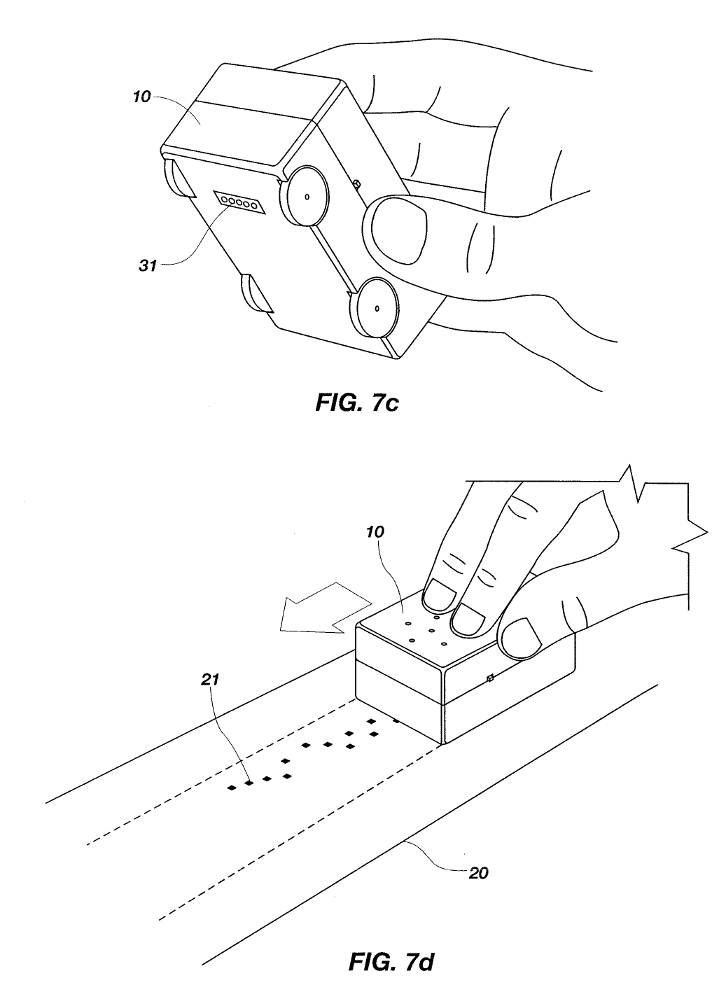

Alternative Variation: Alternatively, conductive ink patterns 20 that are normally printed using conventional printing means can be composed by, and added to, the activation strip 20 by the user. The application method can consist of a stamp, marker, pen, pencil, or similar writing or decorating device. The device deposits conductive ink or similar conductive material. Conductive ink patterns are properly positioned with the aid of positioning marks as shown in FIG. 6 of the drawings, the positioning marks can come in a variety different shapes, sizes and configurations.

Alternative Variation: Alternatively, in addition to the use of conductive ink, the activation strip 20 can be printed with non conductive ink strip decorative and informational purposes.

Alternative Variation: Alternatively, multiple conductive ink patterns 21 can be applied to an activation strip 20. These different patterns can reside on the same side of the activation strip or on different sides.

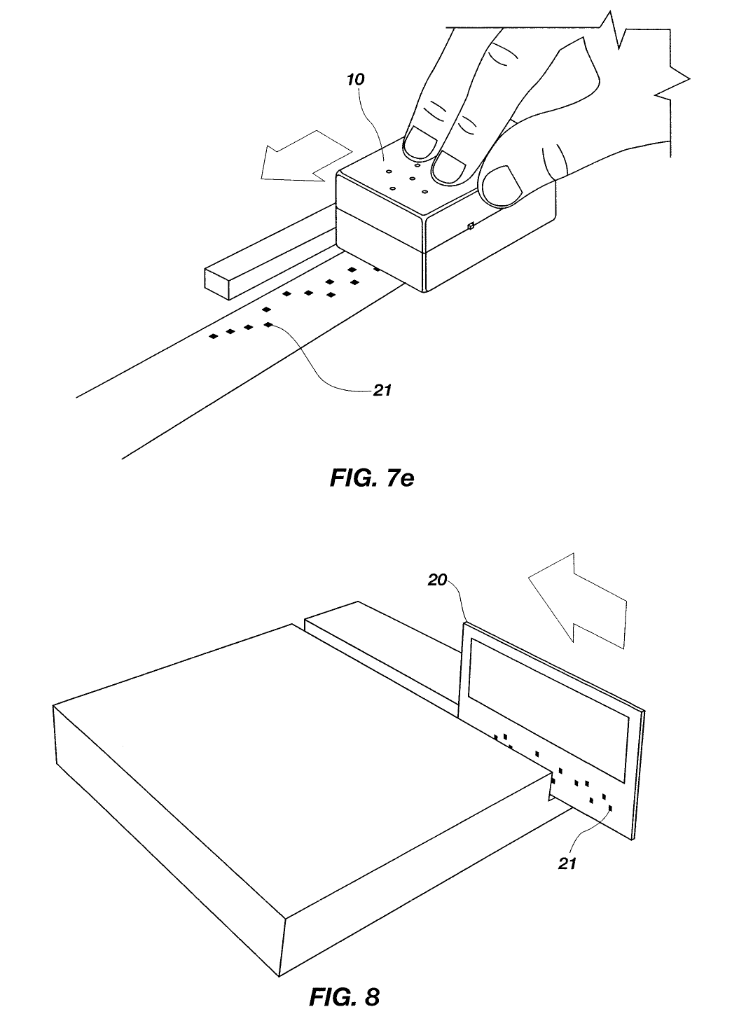

Alternative Variation: Alternatively, the contacts 31 may be positioned on an outer surface of the housing 10. As shown in FIGS. 7a, 7b, and 7c. Furthermore, a reconfigured channel 13 could be used shown in FIG. 7a. In this configuration, the housing 10 with exposed contacts 31 as shown in FIGS. 7a and 7b, would be transported over, and in contact with, an activation strip 20 or similar surface with printed with a conductive ink pattern 21 as show in FIG. 7. The contacts, now positioned on the outside of the housing and lacking the previous functionality of the pressure ribs 43 and contact guide 40, would be positioned to make proper contact with the conductive ink pattern 21 and may employ springs or other similar means to ensure contact.

Alternative Variation: Alternatively, the housing may have wheels, rollers or other similar elements to help transport the housing 11 with external contacts 31 as shown in FIG. 7c.

Alternative Variation: Alternatively, visual alignment guidelines printed on the surface of the activation strip 20 as shown in FIG. 7d can be used to align a housing 10 with external contacts as shown in FIGS. 7a, b, and c with a conductive ink pattern 21 such as shown in FIGS. 7d.

Alternative Variation: Alternatively, another object such as the edge could guide the housing 10 and provide proper alignment between the contacts 31 and the conductive ink pattern 21 as shown in FIG. 7e.

Alternative Variation: Alternatively, conductive ink patterns 21 can be positioned in more than one direction on the same side of an activation strip 20.

Alternative Variation: Alternatively, the PCBA 30 can be redesigned to achieve many different functions including, but not limited to: the triggering of audio, video, light, animation, graphics, images, or multimedia experiences. Audio experiences can include but are not limited to: the playing of single notes, chords, melodies, song, instruments, special effect sounds, or narration. Music can be played as electronic tones or voice quality music.

The PCBA 30 can be programmed to activate for a predetermined amount of time each time a circuit is closes or it can remain continually activated as long as the circuit is closed.

Alternative Variation: Alternatively, the conductive ink patterns 21 can also be used as codes that unlock programs, information, content and functionality that is stored within memory when the PCBA 30 is activated.

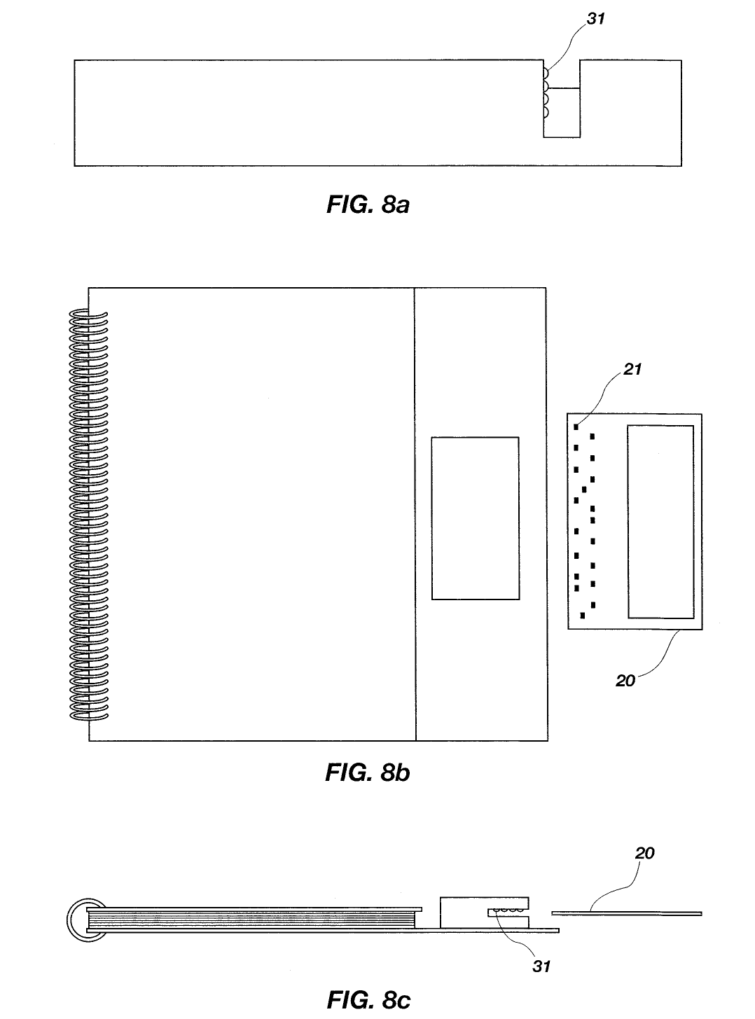

Alternative Variation: Alternatively, the housing 10 can be designed with a swipe card feature where an activation strip 20, can touch the contacts 31 by sliding through a slot. The contacts 31 are exposed within the slot see FIGS. 8 and 8a-c.

Alternative Variation: Alternatively, the conductive ink pattern 21 can be printed on various flexible and rigid materials such as printed paper, board stock, film, plastic, stickers, or other material.

Alternative Variation: Alternatively, the activation strip 20 can be manufactured in a variety of shapes and sizes including, but not limited to: strips, cards, or sheets.

Alternative Variation: Alternatively, the activation strip 20 can be decorated or printed with non-conductive ink.

Alternative Variation: Alternatively, the activation strip 20 can be printed on material that can be rolled, flat, segmented, embossed, die-cut, folded or coated.

Alternative Variation: Alternatively, the activation strip can be transported through the channel manually by using a cranking mechanism or mechanically by using a wind-up power source or electrically by using a motor. The feeding mechanism could consist of 10 rollers or similar method. The transport speed can be constant or intermittent, a prescribed speed or variable speeds. The activation strip 20 can activate the contacts by traveling in the intended direction or in the reverse direction.

Alternative Variation: Alternatively, the housing 10 can be a variety of shapes, sizes, and colors and could resemble a toy, reader, video game, or similar item.

Alternative Variation: Alternatively, the PCBA 30 and integrated circuit 32 can be simple or complex, with or without memory depending on the required functionality.

Alternative Variation: Alternatively, the PCBA 30 can be connected to output devices including, but not limited to: lights, speakers or displays.

Alternative Variation: Alternatively, the conductive ink pattern 21 can be replaced with non-conductive ink and the contacts 31 can be replaced with a light detection unit that detects the dots that make up the ink pattern.

Alternative Variation: Alternatively, the housing 10 is part of a book, or similar publication as shown in FIGS. 8b and 8c, or can utilize a swipe card design shown in FIGS. 8 and 8a.

Alternative Variation: Alternatively, more than one integrated circuit 32 may be used and switching between the integrated circuits to achieve different functionality is possible.

Alternative Variation: Alternatively, the PCBA 30 and or integrated circuit 32 can be designed so that the electronics turn off automatically after being inactive for a period of time.

Alternative Variation: Alternatively, the number of rows comprising the conductive ink pattern 21 and the number of corresponding contacts 31 is variable and can be more or less than the number in the present embodiment.

Alternative Variation: Alternatively, the dots that make up the conductive ink pattern 21 and the associated contacts 31 do not need to be uniform and can vary shape and size.

### H. Operation of Preferred Embodiment

The user begins the activation process by grasping the housing 10, consisting of an upper portion 11 and a lower portion 12, and joined together by the screws 14.

The user then activates the PCBA 30 by turning the on/off switch 36 to the “on” position. This action allows current to flow from the power source 34 through the wires 35 and to the PCBA 30 including the integrated circuit 32. To activate the intended music function, the user inserts the activation strip 20 with conductive ink pattern 21 face down into the “in” channel slot 44. The user pushes the activation strip 20 into the channel 13. As the activation strip 20 slides through the channel 13 it passes beneath the contact guide 40, and comes in contact with the roller 41 which is held in place by the shaft 42. The roller 41 and shaft 42 apply slight pressure to the activation strip 20 and they spin as the activation strip 20 passes by. As the activation strip 20 continues through the channel, it passes over the channel opening 15. Positioned in the channel opening are the contacts 31. The leading end of the activation strip 20 will eventually exit the channel 13 and protrude through the exit channel slot 44. At this point, the user can grasp the activation strip with thumb and forefinger and pull the strip through the channel 13 at a constant speed.

The conductive ink pattern 21 is aligned in rows. Each row aligns with a specific contact 31 positioned within the channel opening 15. The pressure ribs 43 apply pressure to the upward facing surface of the activation strip 20 thereby ensuring that the conductive ink pattern 21 on the underside of the activation strip 20 will come in contact with the contacts 31.

As the activation strip is drawn through the channel by the user, each dot of the conductive ink pattern 21 comes in contact with a specific contact 31. Each conductive ink dot closes a specific circuit thereby activating the PCBA 30. Upon activation, the integrated circuit 32 sends electrical signals to the speaker 33 and sounds are produced by the speaker 33. Sound exits the housing 10 via the sound holes 16. The sounds can be tones, chords, melodies, songs, narration, or the like, depending on how the integrated circuit 32 and PCBA 30 are designed.

The conductive ink dots that make up the conductive ink pattern 21 are spaced at specific intervals so that as the user draws the activation strip 20 through the channel 13, at a predetermined speed, a melody is played. The user may pull the activation strip 20 at an optimal speed, faster or slower, and may even reverse the activation strip's direction of travel in order to play the melody in reverse. When the activation strip exits the exit channel opening 15, the activation strip 20 may be reinserted the same way to play the same melody, or may be inserted to play a different melody if a conductive ink pattern is printed on more than one side of the activation strip 20. Additional activation strips 20 may be inserted to play different melodies. When the user is finished using the device, they turn the on/off switch 36 to the off position.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

What is claimed is:

1. An electrical device activated by conductive ink patterns applied to an activation strip which includes:
a plurality of electrical contacts disposed in an array adjacent to each other; and
reader circuitry connected to said plurality of electrical contacts; and
a housing arranged to contain said reader circuitry and to locate the plurality of electrical contacts;
wherein the housing locates the plurality of contacts to facilitate movement of an activation strip relative to the contacts with the contacts touching the activation strip and the contacts arrayed across the width of the activation strip.

2. An electrical device as claimed in claim 1 wherein a contact acts in combination with a conductive ink marking to provide a switch with the state of said switch being read by the reader circuitry.

3. An electrical device as claimed in claim 2 wherein two adjacent contacts form elements of a switch, said switch being closed when a conductive ink marking is present between the contacts and touches both contacts.

4. An electrical device as claimed in claim 1 wherein the reader circuitry detects changes in electrical resistance of the surface of the activation strip touching at least one contact as the strip moves relative to the contact.

5. An electrical device as claimed in claim 4 wherein the reader circuitry is arranged to differentiate three of more levels of electrical resistance of the surface of a strip touching a contact.

6. An electrical device as claimed in claim 5 wherein the reader circuitry reads a data word from each conductive ink marking with the amount of data present in each word being dependent on the number of resistance levels the reader circuit is arranged to detect.

7. An electrical device as claimed in claim 4 wherein the reader circuitry is arranged to differentiate only two levels of electrical resistance of the surface of a strip touching a contact.

8. An electrical device as claimed in claim 7 wherein the reader circuitry interprets a conductive ink pattern disposed across the width of a strip as a data word containing a number of bits related to the number of contacts.

9. An electrical device as claimed in claim 8 wherein the reader circuitry plays encoded content marked on an activation strip in the order in which contacts touch each data word marked across the width of the strip with the distance between each consecutive data word marked along the length of the strip providing playback timing information.

10. An electrical device as claimed in claim 1 wherein the reader circuitry includes a speaker configured to play audio signals encoded into the conductive ink patterns marked on a activation strip.

11. An electrical device as claimed in claim 1 wherein the reader circuitry includes or is associated with at least one display screen.

12. An electrical device as claimed in claim 1 wherein the electrical device provides an electronic entertainment device that is activated by conductive ink patterns.

13. An electrical device as claimed in claim 12 wherein the direction of movement and speed of movement of an activation strip relative to the contacts modifies the playback of content encoded into the conductive ink patterns by the reader circuitry.

14. An electrical device as claimed in claim 12 wherein the reading of encoded content from an activation strip by the reader circuitry triggers playback of a series of individual notes or a song.

15. An electrical device as claimed in claim 12 wherein the reading of encoded content from an activation strip by the reader circuitry triggers one or more entertainment playback actions including playback of vocal narratives, sound effects, musical compositions, visual images, audio, video or video animation.

16. An electrical device as claimed in claim 12 wherein the reader circuitry includes or is associated with at least one memory element configured to store entertainment content, with content read from an activation strip providing an access retrieval address for said stored entertainment content.

17. An electrical device as claimed in 1 wherein the contacts are moved relative to the strip and the strip remains stationary when encoded content is read from an activation strip.

18. An electrical device as claimed in claim 17 wherein the housing includes at least one roller element to assist the motion of the contacts over the strip.

19. An electrical device as claimed in claim 17 wherein the housing includes at least one substantially linear guide edge provided on a side of the housing to guide the motion of the contacts over a strip when the guide edge is engaged with a guide rail.

20. An electrical device as claimed in claim 17 wherein the housing includes at least one alignment marking on a front face of the housing to assist in aligning the contacts with the conductive ink patterns marked on a strip as the contacts move over the strip.

21. An electrical device as claimed in claim 17 wherein an underside surface of the housing includes at least one channel arranged to receive a strip and to guide the motion of the contacts over the strip.

22. An electrical device as claimed in claim 1 wherein the strip is moved relative to the contacts and the contacts remain stationary when encoded content is read from the strip.

23. An electrical device as claimed in claim 22 wherein the housing includes a channel to guide the motion of the strip over the contacts.

24. An electrical device as claimed in claim 23 wherein the entire front or rear end of a strip is inserted into the channel to control the motion of the strip over the contacts.

25. An electrical device as claimed in claim 23 wherein the channel includes a contact guide.

26. An electrical device as claimed in claim 24 wherein the housing includes a feed mechanism to promote motion of the strip over the contacts.

27. An electrical device as claimed in claim 23 wherein a portion only of the front or rear end of a strip is inserted into the channel to control the motion of the strip over the contacts.

28. An electrical device as claimed in claim 1 wherein the electronic device is formed integrally with an additional article.

29. An electrical device strip as claimed in claim 28 wherein the article is a book.

30. An electrical device as claimed in claim 12 wherein different conductive patterns marked on different activation strips result in different playback actions by the reader circuitry.

31. An activation strip formed from a media capable of retaining applied conductive ink patterns,
said media being marked with conductive ink patterns capable of being read by an electronic device,
wherein the media is formed into a strip capable of relative movement with respect to an array of contacts formed within said electronic device to read content encoded within the conductive ink patterns marked on the media.

32. An activation strip as claimed in claim 31 wherein the media provides at least one surface for the application of conductive ink patterns.

33. An activation strip as claimed in claim 32 wherein the conductive ink pattern are applied to both sides of the activation strip.

34. An activation strip as claimed in claim 31 wherein conductive ink patterns are marked on various flexible and rigid media including printed paper, board stock, film, plastic sheets, or stickers.

35. An activation strip as claimed in claim 31 wherein an activation strip is formed in the shape of a strip, card or sheet.

36. An activation strip as claimed in claim 31 wherein the conductive ink patterns are formulated to close at least one circuit or switch when they touch electrical contacts of an electronic device.

37. An activation strip as claimed in claim 31 wherein conductive ink markings composing a pattern are aligned across the width of the strip.

38. An activation strip as claimed in claim 31 wherein a conductive ink pattern includes marking oriented in two directions.

39. An activation strip as claimed in claim 31 wherein the length of conductive ink pattern marked of the activation strip controls the amount of content capable of being read from the activation strip by an electronic device.

40. An activation strip as claimed in claim 31 wherein conductive ink patterns are applied or marked by using conventional printing means.

41. An activation strip as claimed in claim 40 wherein the printing method uses a stamp, marker, pen, pencil, or similar writing or decorating device.

42. An activation strip as claimed in claim 31 wherein a conductive ink pattern is applied to the activation strip using printing machinery.

43. An activation strip as claimed in claim 31 wherein the activation strip is decorated with non-conductive ink.

44. An activation strip as claimed in claim 31 wherein the leading edge of the activation strip is shaped for insertion into a channel formed in an electronic device.

45. An activation strip as claimed in claim 31 wherein visual alignment guidelines are printed on a surface of the activation strip to align the contacts of an electronic device with a conductive ink pattern.
